(19) United States
(12) Patent Application Publication
(10) Pub. No.: US 2023/0377290 A1
(43) Pub. Date: Nov. 23, 2023

(54) SYSTEM AND SYSTEM CONTROL METHOD

(71) Applicant: CANON KABUSHIKI KAISHA, Tokyo (JP)

(72) Inventor: TSUYOSHI KANEKO, Kanagawa (JP)

(21) Appl. No.: 18/303,764

(22) Filed: Apr. 20, 2023

(30) Foreign Application Priority Data
May 19, 2022 (JP) 2022-082650

(51) Int. Cl. G06T 19/00; G02B 27/01

(52) U.S. Cl. CPC G06T 19/006; G02B 27/017

(57) ABSTRACT

A system that manages a virtual object includes an anchor management unit that manages feature amounts in the real world for displaying a virtual object in linkage with the real world in association with identification information corresponding to the virtual object, and the anchor management unit manages conditions for determining a method of providing the virtual object to a user in association with the identification information.

### CROSS REFERENCE TO PRIORITY APPLICATION

This application claims the benefit of Japanese Patent Application No. 2022-082650, filed May 19, 2022, which is hereby incorporated by reference herein in its entirety.

### BACKGROUND OF THE INVENTION

### Field of the Invention

The present invention relates to a system that manages a virtual object.

### Description of the Related Art

Technologies that create a space that provides simulated experiences by combining real and virtual worlds such as virtual reality (VR), augmented reality (AR), and mixed reality (MR) are attracting attention. XR is a generic term for these. In recent years, a mechanism for displaying one virtual object at the same place in the real world on a plurality of terminals has been realized on platforms provided by respective companies. For example, there is a cloud system that manages a virtual object to be disposed in the real world in association with feature amounts of the real world captured by a camera or the like. By capturing the real world that matches the feature amounts managed by the system with a camera of any terminal, the virtual object managed in association with the feature amounts can be viewed on the terminal. Japanese Patent Laid-Open No. 2015-118578 discloses a technique for switching display of a specific virtual object by using user action information or physical environment information. For example, in the initial state, a simple blue globe as a virtual object is displayed, and if a user takes an action such as gazing at the globe, the globe switches to a representation of continents.

However, when providing XR services to users, there are cases where a plurality of virtual objects are disposed at the same position by a virtual object provider. For example, if the virtual object provider wants to change an object to be displayed according to a user's age, gender, contract details with the user, a situation in which the user is placed, or the like, a plurality of virtual objects are disposed at the same position. If a plurality of virtual objects are disposed at the same position, a user terminal acquires a plurality of pieces of anchor information from a virtual object management server and thus cannot determine which object is to be displayed to a user.

The present invention provides a system that provides virtual objects according to user information.

### SUMMARY OF THE INVENTION

According to the present invention, there is provided a system including a memory storing instructions; and a processor executing the instructions causing the system to: manage feature amounts in a real world for displaying a virtual object in linkage with the real world in association with identification information corresponding to the virtual object, and manage conditions for determining a method of providing the virtual object to a user in further association with the identification information.

Further features of the present invention will become apparent from the following description of exemplary embodiments with reference to the attached drawings.

### BRIEF DESCRIPTION OF THE DRAWINGS

FIG. 1 is a diagram showing a configuration of a virtual object management system.

FIG. 2 is a diagram showing a hardware configuration of a client terminal.

FIG. 3 is a diagram showing a hardware configuration of the virtual object management server.

FIG. 4 is a diagram showing a software configuration of the virtual object management system.

FIGS. 5A to 5C are diagrams showing an example of screen display of the client terminal.

FIG. 6 is a sequence diagram showing a flow of a process of registering and drawing a virtual object.

FIG. 7 is a flowchart showing a process of determining a virtual object to be provided to the client terminal.

### DESCRIPTION OF THE EMBODIMENTS

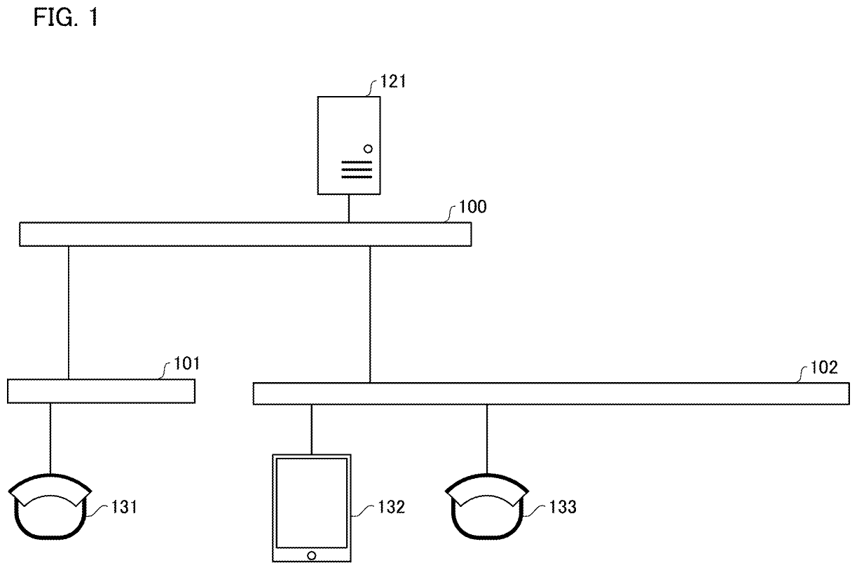

FIG. 1 is a diagram showing the overall configuration of a system that manages a virtual object. The virtual object management system includes a virtual object management server 121 that provides a virtual object, and a client terminal that can project the virtual object provided from the virtual object management server 121 into the real world. In the present embodiment, an example in which client terminals 131 to 133 are connected to the virtual object management server 121 as client terminals will be described.

The client terminal 131 is connected to the virtual object management server 121 via a network 100 and a network 101. The client terminal 132 and the client terminal 133 are connected to the virtual object management server 121 via the network 100 and the network 101. The network 100 is the Internet, and the networks 101 and 102 are the Internet, networks in general homes, companies, or schools, and wireless LANs set up in towns. The networks 100 to 102 may be so-called communication networks realized by, for example, LANs such as the Internet, WANs, telephone lines, dedicated digital lines, ATMs, frame relay lines, cable television lines, and wireless lines for data broadcasting. The networks 100 to 102 need only be capable of transmitting and receiving data.

The client terminals 131 to 133 are terminals capable of imaging the real world, displaying a virtual object, and communicating with the virtual object management server 121 in order to project the virtual object into the real world. The client terminals 131 to 133 are, for example, dedicated hardware such as head mounted displays (HMDs) or smart glasses that support drawing of virtual objects handled by XR, or communication devices such as smartphones that have a built-in program execution environment. If the client terminals 131 to 133 are not dedicated hardware capable of drawing virtual objects, such as smartphones, a virtual object is drawn by using an API provided by a web browser or an OS. The client terminals 131 to 133 each have a camera that images the surroundings and a display that displays a virtual object. The client terminals 131 to 133 image the surroundings via the cameras or the like, and project and display a virtual object in the real world imaged by the cameras on the displays, and thus provide users with simulated experiences in which the real world and the virtual world are combined.

The virtual object management server 121 provides a service of providing virtual objects to external terminals. The virtual object management server 121 is constructed by using, for example, a server computer. In the present embodiment, an example in which the virtual object provision service is provided by the virtual object management server 121 will be described, but the present invention is not limited to this. Services or functions provided by the virtual object management server 121 may be realized by not only one or a plurality of information processing apparatuses but also a virtual machine (cloud service) using resources provided by a data center including an information processing apparatus or a combination thereof.

As a part of the virtual object provision service, the virtual object management server 121 manages a virtual object disposed in the real world in association with feature amounts of the real world captured by the camera or the like. In the present embodiment, a virtual object and feature amounts of the real world captured by the camera or the like, managed by the virtual object management server 121, are associated with each other and managed by using an anchor. The anchor includes a virtual object, feature amounts of the real world for displaying the virtual object in association with the real world, an identifier for identifying the anchor, and a session ID. The anchor of the present embodiment includes property information including conditions (various parameters) for determining a method of providing the virtual object to a user. The anchor manages at least three types of information, such as a feature amount, position information, and sensor information in Table 1 that will be described later, as the feature amounts for displaying the virtual object in association with the real world. The virtual object management server 121 receives anchor registration requests from the client terminals 131 to 133 and manages registered anchors. The virtual object management server 121 returns anchors that satisfy conditions from the managed anchors in response to anchor acquisition requests from the client terminals 131 to 133. The virtual object management server 121 also manages information regarding users using the client terminals 131 to 133. The virtual object management server 121 receives user login/logout requests from the client terminals 131 to 133 and performs login/logout processing.

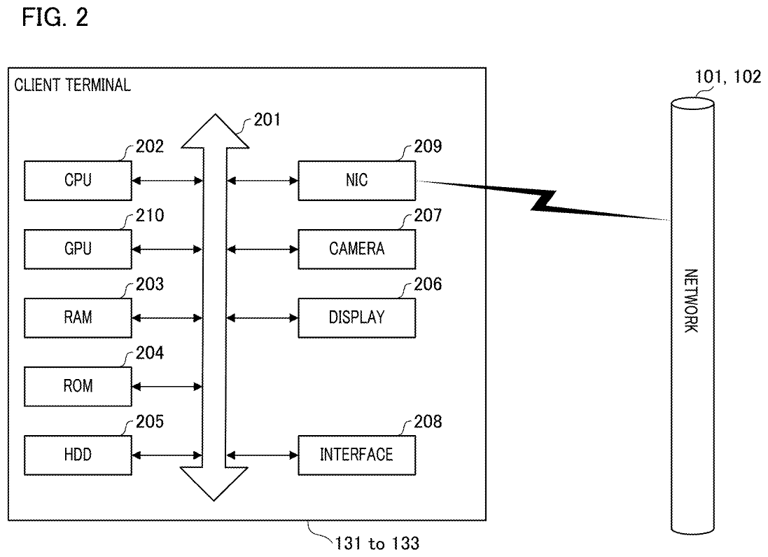

FIG. 2 is a diagram showing a hardware configuration of the client terminals 131 to 133. The client terminals 131 to 133 each have a CPU 202, a GPU 210, a RAM 203, a ROM 204, an HDD 205, an NIC 209, a camera 207, a display 206, and an interface 208. These constituents are connected to a system bus 201.

The central processing unit (CPU) 202 controls the entire terminal. The graphics processing unit (GPU) 210 performs a calculation process necessary for drawing a virtual object in real time. The random access memory (RAM) 203 is a temporary storage unit, and functions as a main memory, work area, and the like for the CPU 202 and the GPU 210. The read only memory (ROM) 204 is a data read-only memory, and stores various types of data such as basic I/O programs. The hard disc drive (HDD) 205 is a large-capacity memory, and stores application programs such as web browsers, an operating system (OS), related programs, various data, and the like. The HDD 205 is an example of a storage device, and may be a memory such as a solid state drive (SSD) or an external storage device. The CPU 202 loads a program stored in a memory (the ROM 204 or the HDD 205) into the RAM 203 and executes the program, and thus comprehensively controls each unit connected to the system bus 201.

The display 206 is a display unit configured to display virtual objects, information necessary for operations, and the like. If the client terminal is a smartphone, a tablet terminal, or the like, the display 206 may be a touch panel in which a display unit and an input unit are integrated. By associating input coordinates and display coordinates on the touch panel, a GUI can be configured such that a user can directly operate a screen displayed on the touch panel.

The camera 207 is an out-camera that images the surroundings, an in-camera that mainly images the user, or the like. By analyzing a video captured by the camera 207 with the application program stored in the HDD 205, it is possible to dispose a virtual object to be superimposed on the real world and to calculate feature amounts of the real world. If the client terminals 131 to 133 are dedicated terminals for XR such as HMDs, it is also possible to operate a virtual object displayed on the display 206 through the user's finger movements recognized by the camera 207. If the client terminals 131 to 133 are not dedicated terminals for XR such as smartphones, a virtual object displayed on the display 206 can be operated by operating the touch panel of the display 206 or the like.

The network interface card (NIC) 209 is a network interface that exchanges data with external devices such as the virtual object management server 121 via the networks 101 and 102. The interface 208 is an interface with an external device, and connects peripheral devices such as various external sensors. The configuration in FIG. 2 is an example, and configurations of the client terminals 131 to 133 are not limited to this. For example, storage locations of data and programs can be changed to the ROM 204, the RAM 203, the HDD 205, and the like according to characteristics thereof.

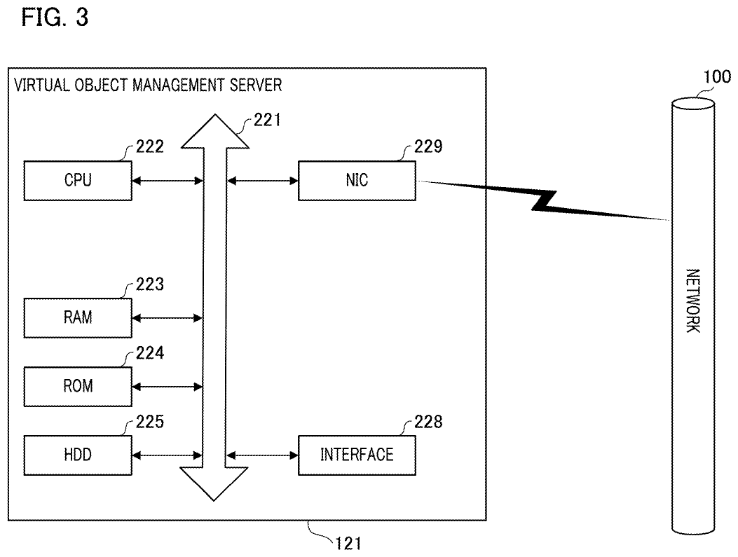

FIG. 3 is a diagram showing a hardware configuration of the virtual object management server 121. The virtual object management server 121 has a CPU 222, a RAM 223, a ROM 224, an HDD 225, an NIC 229, and an interface 228. These constituents are connected to a system bus 221. The CPU 222 controls the virtual object management server 121. The RAM 223 is a temporary storage unit, and functions as a main memory, a work area, and the like for the CPU 222. The ROM 224 is a data read-only memory and stores various types of data such as basic I/O programs. The HDD 225 is a large-capacity memory and stores programs of a service server group, an operating system (OS), related programs, various types of data, and the like. The CPU 222 loads a program stored in a memory (the ROM 224 or the HDD 225) into the RAM 203 and executes the program, and thus comprehensively controls each unit connected to the system bus 221.

The NIC 229 is a network interface that exchanges data with external devices such as the client terminals 131 to 133 via the network 100. The interface 228 is an interface with an external device, and connects peripheral devices. The configuration in FIG. 3 is an example, and a configuration of the virtual object management server 121 is not limited to this.

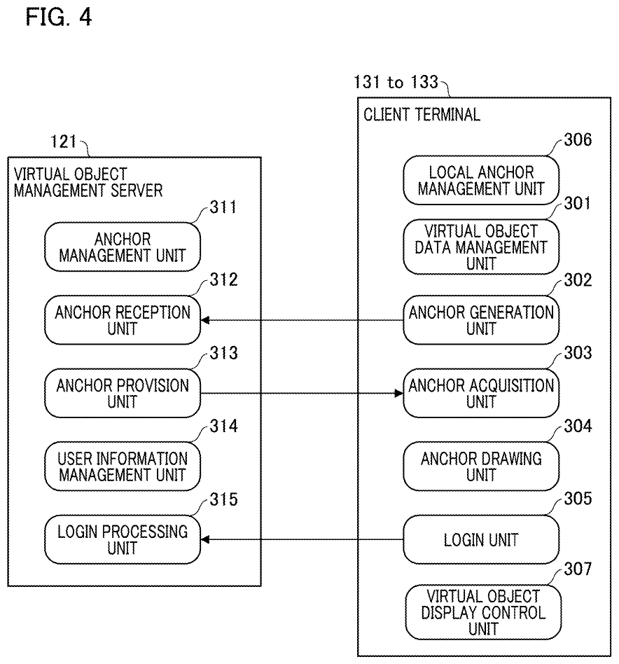

FIG. 4 is a diagram showing a software configuration of the virtual object management system according to the present embodiment. A software configuration of the client terminals 131 to 133 shown in FIG. 4 is realized by the CPU 202 and the GPU 210 executing processing on the basis of programs stored in the memory (the ROM 204 or the HDD 205). Similarly, the software configuration of the virtual object management server 121 shown in FIG. 4 is realized by the CPU 222 executing processing on the basis of programs stored in the memory (the ROM 224 or the HDD 225).

The client terminals 131 to 133 each have a virtual object data management unit 301, an anchor generation unit 302, an anchor acquisition unit 303, an anchor drawing unit 304, a login unit 305, a local anchor management unit 306, and a virtual object display control unit 307. The virtual object data management unit 301 manages 3D data of a virtual object. The 3D data in various formats stored in the virtual object data management unit 301 is a virtual object that can be freely disposed to be superimposed on the real world by a user.

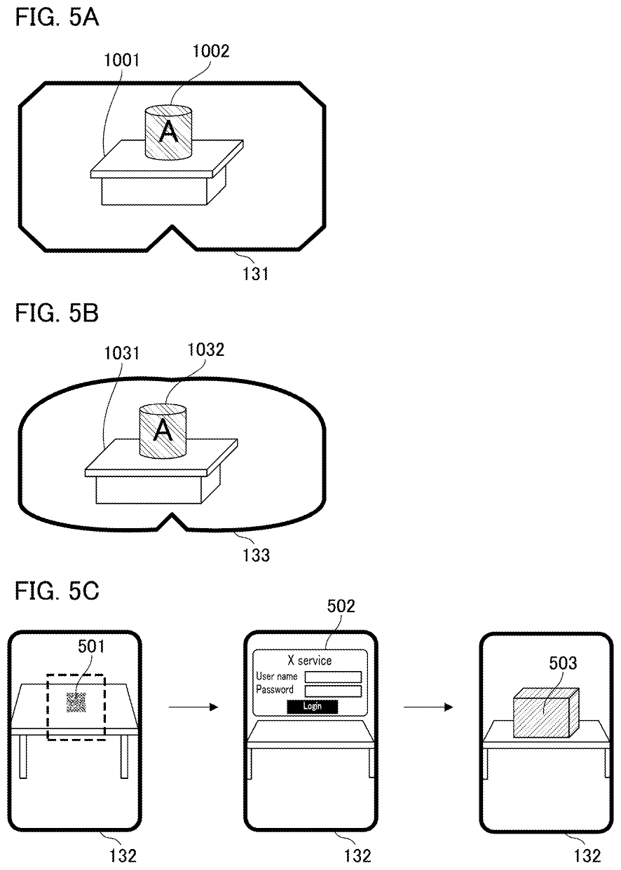

The anchor generation unit 302 generates an anchor through a user's operation. The user selects a 3D model stored in the virtual object data management unit 301 via the anchor generation unit 302, and disposes a virtual object in the real world on the basis of movements of the fingers imaged by the camera 207 or an operation of the touch panel of the display 206. An example of display of a virtual object on the client terminal will be described with reference to FIGS. 5A to 5C. FIG. 5A is a diagram showing an image (video) displayed on the display 206 of the HMD type client terminal 131. A desk 1001 is a desk in the real world imaged by the camera 207. A cylindrical virtual object 1002 is a cylindrical virtual object stored in the virtual object data management unit 301 of the client terminal 131. The user disposes the cylindrical virtual object 1002 on the desk 1001 in the real world by, for example, operating the virtual object 1002 with a gesture.

When the virtual object is disposed, the anchor generation unit 302 analyzes the image, extracts feature amounts of the surroundings in which the virtual object is disposed, and associates the feature amounts with the virtual object to be stored in the local anchor management unit 306. The anchor generation unit 302 uses a GPS sensor connected via the interface 208 to specify position information of the virtual object and associates the position information with an anchor. A user may associate an anchor with a sensor via the anchor generation unit 302. The local anchor management unit 306 manages anchors in each client terminal. The local anchor management unit 306 stores and manages anchors generated by each client terminal and anchors acquired from the virtual object management server 121.

The anchor acquisition unit 303 acquires an anchor from the virtual object management server 121. Specifically, the anchor acquisition unit 303 transmits an anchor acquisition request to the virtual object management server 121, and receives an anchor from the virtual object management server 121 as a response to the anchor acquisition request. The anchor acquired from the virtual object management server 121 is stored in the local anchor management unit 306.

The anchor drawing unit 304 disposes a virtual object included in the anchor in the real world on the basis of feature amounts included in the anchor. The anchor drawing unit 304 compares the feature amounts included in each anchor stored in the local anchor management unit 306 with a video of the real world captured by the camera 207, and disposes the virtual object included in the anchor in a portion where feature amounts of a region in the real space match. FIG. 5B is a diagram showing an image (video) displayed on the display 206 of the HMD type client terminal 133. FIG. 5B shows a state in which the cylindrical virtual object 1002 disposed on the desk 1001 by the user in the client terminal 131 is projected as a cylindrical virtual object 1032 on a desk 1031 with the same feature amounts on the client terminal 133. The anchor corresponding to FIG. 5A generated by the client terminal 131 and provided to the virtual object management server 121 may be acquired by the client terminal 133, and the virtual object may be drawn on the basis of the anchor to display FIG. 5B.

The login unit 305 performs a user authentication process. The authentication process is performed by using, for example, a combination of a user name and a password. The login unit 305 displays a login screen on the display 206 of the terminal. FIG. 5C is a diagram showing an example of a login screen. When the image code 501 is read by the camera 207 of the client terminal 132, a login screen 502 is displayed. The login unit 305 transmits a user name and a password entered on the login screen to the login processing unit 315 of the virtual object management server 121. The user name and the password are entered by, for example, movements of the user's fingers imaged by the camera 207, an operation on the touch panel of the display 206, a keyboard connected to the interface 208, or the like. User authentication is performed in the login processing unit 315, and if the user can log in to a service that provides the virtual object, a virtual object 503 can be displayed. A login method is not limited to a combination of a user name and a password. For example, face authentication using a face image captured by the camera 207, iris authentication using an iris, or biometric authentication such as fingerprint authentication using a fingerprint sensor connected to the interface 208 may be used. The virtual object display control unit 307 controls various edits and operations by the user on the virtual object displayed on the display 206 of the client terminal.

The virtual object management server 121 has an anchor management unit 311, an anchor reception unit 312, an anchor provision unit 313, a user information management unit 314, and a login processing unit 315. The anchor management unit 311 manages anchors. Table 1 is an example of an anchor management table managed by the anchor management unit 311. The anchor includes an anchor ID, a session ID, virtual object data, feature data, position information, sensor information, a gender, time, and the like.

TABLE 1

| | | VIRTUAL | | | | | | | |
|---|---|---|---|---|---|---|---|---|---|
| ANCHOR | SESSION | OBJECT | FEATURE | POSITION | SENSOR | | | | |
| ID | ID | DATA | DATA | INFORMATION | INFORMATION | | GENDER | TIME | . . . |
| a | 111 | aaa.obj | xxx.dat | (1, 23, 31) | Beacon | 123 | MALE | | . . . |
| b | 222 | bbb.obj | yyy.dat | (1, 3, 22) | Beacon | 123 | FEMALE | | . . . |
| c | 333 | xxx.obj | zzz.dat | (25, 3, 41) | Wifi | 345 | | 6:00-17:59 | . . . |
| d | 111 | ddd.obj | aaa.dat | (10, 101, 1) | Wifi | 345 | | 18:00-23:59 | . . . |

| | | | | | | | | |
|---|---|---|---|---|---|---|---|---|
| . | . | . | . | . | . | . | . | . |
| . | . | . | . | . | . | . | . | . |
| . | . | . | . | . | . | . | . | . |

The anchor ID is identification information for uniquely identifying the anchor, and is also identification information corresponding to a virtual object. The anchor ID is assigned when the anchor reception unit 312 stores a record in the anchor management table. The session ID is an identifier for associating a plurality of anchors as one group. In a case of anchors of the same session, the same session ID is added. By associating a plurality of anchors with one session ID, a plurality of anchors with the same session ID can be presented to a user at the same time. In other words, in a provision method determined with the session ID as a condition, it is possible to provide another virtual object different from a certain virtual object.

The virtual object data is data regarding a 3D model of a virtual object in any format. The feature data, the position information, and the sensor information are feature amounts for displaying the virtual object in association with the real world. The feature data indicates real-world three-dimensional information obtained by analyzing data in which the camera 207 images the surroundings in which the anchor is disposed, for example. The position information is information indicating a three-dimensional position of a virtual object in the real world. The sensor information includes information regarding a location (GPS coordinates) where the anchor is disposed, an ID of Beacon or Wifi associated with the anchor, and the like. A location where the virtual object is installed can be specified from the ID of Beacon or Wifi associated with the anchor. The gender and the time are an example of property information that is a condition for determining a method of providing the virtual object to the user. The property information is information that is referred to when determining the anchor to be provided to the client terminal, and virtual object data returned by the virtual object management server 121 is determined according to a gender of the user who has requested the virtual object or the time of request. The property information is not limited to a gender and time. The property information may include, for example, settings based on the user's progress in a virtual object provision service such as stages, settings based on the user's personal attributes such as a gender, an age, and a member rank, and settings based on an environment to which the user belongs, such as the season and date. The settings based on the user's progress in the virtual object provision service include whether or not the user has consented to a contract (EULA).

The anchor reception unit 312 receives an anchor registration request from the client terminals 131 to 133. The anchor reception unit 312 stores an anchor included in the received anchor registration request in the anchor management unit 311. The anchor provision unit 313 receives an anchor acquisition request from the client terminals 131 to 133, searches for anchors that match conditions from the anchor managing unit 311, and returns the anchors to the client terminals 131 to 133.

The user information management unit 314 is a user management unit configured to manage information regarding a user using the virtual object management system. Tables 2 and 3 are examples of user information management tables managed by the user information management unit 314. Table 2 is an example of a user attribute information management table. Table 3 is an example of a user progress information management table. In the present embodiment, an example in which a user progress status in the virtual object management system is managed with another table different from a table for managing user attribute information will be described, but may be managed with one table, or may be managed with a plurality of tables.

TABLE 2

| USER | USER | | | | | |
|---|---|---|---|---|---|---|
| ID | NAME | PASSWORD | AGE | GENDER | CREATOR | . . . |
| U001 | A | xxxx | 10 | MALE | X | . . . |
| U002 | B | xxxx | 21 | FEMALE | X | . . . |
| U003 | C | xxxx | 24 | FEMALE | X | . . . |
| U004 | D | xxxx | 43 | MALE | X | . . . |
| U024 | X | xxxx | 32 | MALE | O | . . . |
| . | . | . | . | . | . | . |
| . | . | . | . | . | . | . |
| . | . | . | . | . | . | . |

TABLE 3

| USER ID | EULA CONSENT STATUS | . . . |
|---|---|---|
| U001 | X | . . . |
| U002 | ◯ | . . . |
| U003 | ◯ | . . . |
| U004 | ◯ | . . . |
| . | . | . |
| . | . | . |
| . | . | . |

The user attribute information management table manages user attribute information such as a user ID, a user name, a password, an age, a gender, and a creator. The user ID is information for uniquely identifying a user. The user name is the name set by the user. The password is a password used for login authentication, set by the user. The age is an age set by the user, and the gender is a gender set by the user. The creator is information indicating whether the user is a creator of a virtual object.

The user progress information management table manages a user ID and an EULA consent status. The user ID is information for uniquely identifying a user managed in the user attribute information management table. The EULA consent status is information indicating whether or not EULA has been agreed. Consent to EULA is required to use a service provided by the virtual object management system, and a status of consent to EULA is managed in association with the user ID as progress information in the service.

The login processing unit 315 receives a login request from the client terminals 131 to 133, collates the login request with the user information managed by the user information management unit 314, and returns a login processing result to the client terminals 131 to 133. If information of the login request matches the user information managed by the user information management unit 314 as a result of collation, the login processing unit 315 returns the login processing result as success to the client terminals 131 to 133.

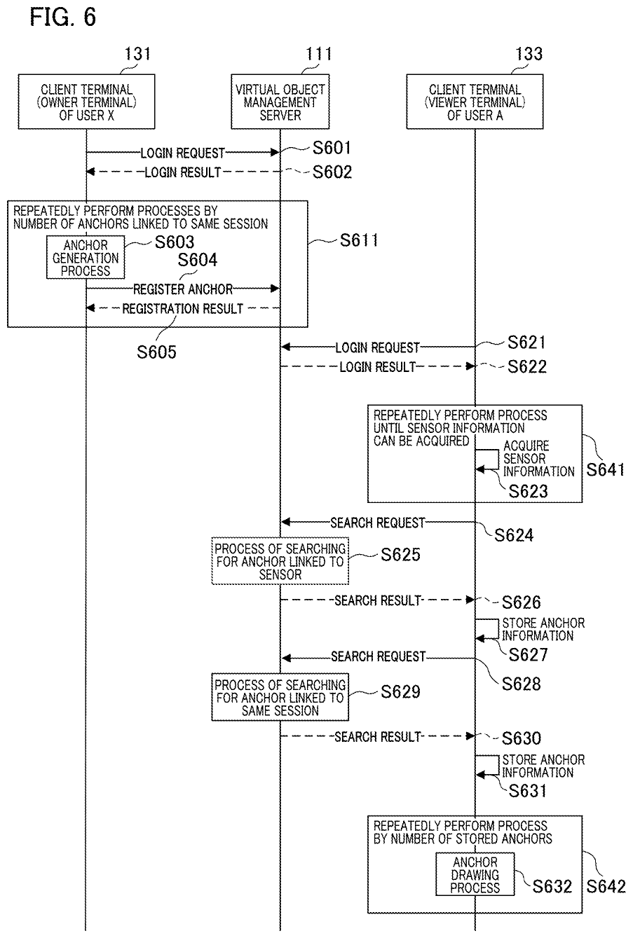

FIG. 6 is a sequence diagram showing a flow of a process of registering and drawing a virtual object. FIG. 6 shows a process from registering an anchor generated by the client terminal 131 in the virtual object management system 111 to acquiring and displaying the anchor stored in the virtual object management system 111 in the client terminal 133. It is assumed that a user who operates the client terminal 131 is “X” and a user who operates the client terminal 133 is “A”. The user “X” is a user whose user ID is U024 in Table 2, and the user “A” is a user whose user ID is U001 in Table 2. The process executed by the client terminal shown in FIG. 6 is realized by the CPU 202 or GPU 210 of the client terminal reading a program stored in the memory to the RAM 203 and executing the program. The process executed by the virtual object management server 121 shown in FIG. 6 is realized by the CPU 222 of the virtual object management server 121 reading a program stored in the memory to the RAM 223 and executing the program.

First, a sequence in which the client terminal 131 operated by the user “X” registers an anchor in the virtual object management server 121 from S601 to S605 will be described. In S601, the login unit 305 of the client terminal 131 transmits a user ID and a password entered by the user to the login processing unit 315 of the virtual object management server 121. In S602, the login processing unit 315 of the virtual object management server 121 verifies the user information received from the client terminal 131 and returns a user authentication processing result for login to the client terminal 131. For example, when the login processing unit 315 confirms that the user information received from the client terminal 131 matches the user ID and the password of the user “X” managed by the user information management unit 314, the login processing unit 315 determines that the login is successful. The login processing unit 315 returns login success to the client terminal 131 as a login result.

In S603, the anchor generation unit 302 of the client terminal 131 generates an anchor for a virtual object stored in the virtual object data management unit 301, disposed by user “X”, and stores the anchor in the local anchor management unit 306. When an anchor is generated, the user “X” may set conditions for determining a method of providing the virtual object to the user. That is, a method of providing the virtual object to the user can be set by an owner who has generated the virtual object. In S604, the anchor generation unit 302 of the client terminal 131 transmits an anchor registration request for the anchor generated in S603 to the anchor reception unit 312 of the virtual object management server 121. In S605, the anchor reception unit 312 of the virtual object management server 121 registers the anchor received from the client terminal 131 in the anchor management unit 311 and returns a registration result to the anchor generation unit 302 of the client terminal 131. If it is desired to register a plurality of anchors with the same session ID, the series of processes (S603 to S605) shown in S611 are repeatedly performed.

Next, a sequence in which the client terminal 133 operated by the user “A” acquires and displays the virtual object from the virtual object management server 121 in S621 to S632 will be described. In S621, the login unit 305 of the client terminal 133 transmits the user ID and the password entered by the user to the login processing unit 315 of the virtual object management server 121. In S622, the login processing unit 315 of the virtual object management server 121 verifies the user information received from the client terminal 131 and returns a user authentication processing result for login to the client terminal 133. For example, when the login processing unit 315 confirms that the user information received from the client terminal 133 matches the user ID and the password managed by the user information management unit 314, the login processing unit 315 returns a login result to the client terminal 131 as login success.

In S623, the anchor acquisition unit 303 of the client terminal 133 acquires sensor information. For example, the anchor acquisition unit 303 acquires a signal from a Beacon terminal as sensor information via a sensor that detects Bluetooth signals and is connected to the client terminal 133 via the interface 208. The sensor information to be acquired may be information regarding Wifi to which the client terminal 133 is connected, information read from an image code via the camera 207, or the like. If sensor information cannot be acquired, the anchor acquisition unit 303 repeatedly performs the process in S623 until the sensor information can be acquired, as shown in S641.

In S624, the anchor acquisition unit 303 of the client terminal 133 transmits a virtual object provision request (anchor search request) to the anchor provision unit 313 of the virtual object management server 121. The anchor search request includes at least one of anchor identification information (that is, identification information corresponding to the virtual object), feature amounts in the real world for displaying the virtual object, and user information. For example, the anchor search request includes the user information and the sensor information acquired in S623. For example, when a signal from a Beacon terminal with id=123 is detected in S623, the anchor acquisition unit 303 transmits an anchor search request associated with the Beacon terminal with id=123 together with the user information of the user “A” to the anchor provision unit 313. In the present embodiment, an example in which, in addition to the user information, sensor information which is one of the feature amounts in the real world for displaying the virtual object is acquired in S623 and is used to request the virtual object management server 121 to provide a virtual object has been described. However, the present invention is not limited to this, and the information acquired in S623 and transmitted to the virtual object management server 121 in S624 may be other information indicating feature amounts, or identification information corresponding to the virtual object.

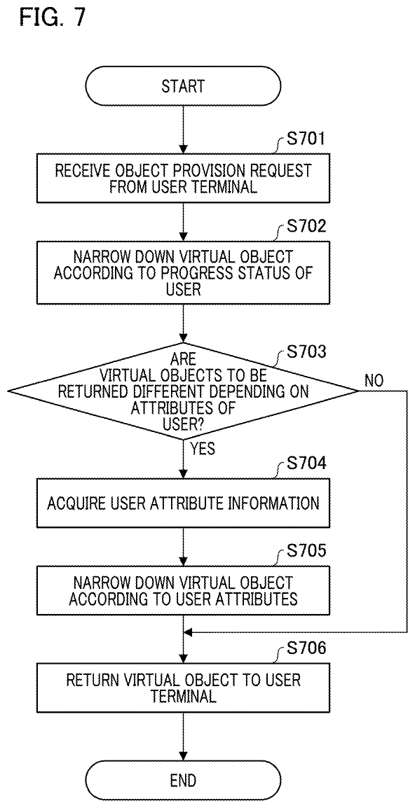

In S625, the anchor provision unit 313 of the virtual object management server 121 searches for an anchor from the anchor management unit 311 on the basis of the anchor search request received from the client terminal 133, and determines an anchor to be returned to the client terminal 133. For example, if the received request includes identification information corresponding to a virtual object, the anchor provision unit 313 determines information (anchor) of the virtual object corresponding to the identification information as an anchor to be returned. If the received request includes feature amounts, the anchor provision unit 313 narrows down an anchor to be returned on the basis of the feature amounts and anchor information managed by the anchor management unit 311. For example, the anchor provision unit 313 searches the anchor management unit 311 for an anchor associated with the Beacon terminal with id=123 by referring to the user information management table and the like, and determines the anchor as an anchor to be returned. The anchor provision unit 313 narrows down an anchor to be returned according to a provision method determined on the basis of the user information and conditions for providing a virtual object determined by the anchor information managed by the anchor managing unit 311 to a user. Details of the process in S625 based on the conditions will be described with reference to a flowchart of FIG. 7 that will be described later. In S626, the anchor provision unit 313 of the virtual object management server 121 returns the anchor determined in S625 to the anchor acquisition unit 303.

In S627, the anchor acquisition unit 303 of the client terminal 133 stores the anchor acquired from the virtual object management server 121 in the local anchor management unit 306. In S628, the anchor acquisition unit 303 of the client terminal 133 transmits a search request for anchors in the same session as the anchor acquired in S627 to the anchor provision unit 313 of the virtual object management server 121. For example, if the anchor acquisition unit 303 acquires an anchor with the anchor ID “a” in S627, the anchor acquisition unit 303 requests the anchor provision unit 313 to search for the same anchor as the session ID 111 with the anchor ID “a”.

In S629, on the basis of the session ID received from the client terminal 133, the anchor provision unit 313 of the virtual object management server 121 searches the anchor managing unit 311 for an anchor the same session ID but different from the provided anchor. In S630, the anchor provision unit 313 of the virtual object management server 121 returns a search result in S629 to the client terminal 133. If there is an anchor in the same session in the search in S629, the anchor provision unit 313 returns the anchor searched in S629 to the anchor acquisition unit 303 of the client terminal 133. For example, the anchor provision unit 313 searches for an anchor with session ID=111 and transmits the anchor with session ID=111 and the anchor ID “d” to the client terminal 133. On the other hand, if no anchor in the same session is found in the search in S629, the client terminal 133 is notified that there is no anchor belonging to the same session. Through the processes in S628 to S630, the anchor provision unit 313 can provide the client terminal 133 with another virtual object different from the virtual object provided to the client terminal 133 according to the provision method determined with the session ID as a condition.

In S631, the anchor acquisition unit 303 of the client terminal 133 stores the anchor acquired from the anchor provision unit 313 in S630 in the local anchor management unit 306. In S642, the anchor drawing unit 304 of the client terminal 133 draws the virtual object on the basis of the anchor acquired from the virtual object management server 121 and stored in the local anchor management unit 306 in S627 and S631. If there are a plurality of anchors stored in the local anchor management unit 306 in S627 and 5631, as shown in S642, the anchor drawing unit 304 repeatedly performs the virtual object drawing process in S642 by the number of stored anchors.

FIG. 7 is a flowchart showing a process of determining a virtual object to be provided to the client terminal. FIG. 7 is a flowchart showing details of the process in S625 in which the virtual object management server 121 receives an anchor provision request from the client terminal 133, and searches for and determines an anchor to be returned. Here, an example will be described in which the anchor management table managed by the anchor management unit 311 is Table 4, the user attribute information management table managed by the user information management unit 314 is Table 5, and the user progress information management table managed by the user information management unit 314 is Table 6. The description will be made assuming that consent to EULA is required to use a service, and a user “C” uses a service in which virtual objects displayed are different according to attribute information or a progress status of the user.

TABLE 4

| | | VIRTUAL | | POSITION | SENSOR | EULA | | | |
|---|---|---|---|---|---|---|---|---|---|
| ANCHOR | SESSION | OBJECT | FEATURE | INFOR- | INFOR- | CONSENT | | MEMBER | |
| ID | ID | DATA | DATA | MATION | MATION | STATUS | STAGE | RANK | GENDER |
| a | 111 | aaa.obj | xxx.dat | (10, 20, 30) | Beacon: | X | | | |
| | | | | | 123 | | | | |
| b | 111 | bbb.obj | xxx.dat | (10, 20, 30) | Beacon: | O | 1 | PLATINUM | MALE |
| | | | | | 123 | | | | |
| c | 111 | ccc.obj | xxx.dat | (10, 20, 30) | Beacon: | O | 2 | GUEST | |
| | | | | | 123 | | | | |
| d | 111 | ddd.obj | xxx.dat | (10, 20, 30) | Beacon: | O | 2 | PLATINUM | FEMALE |
| | | | | | 123 | | | | |
| . | . | . | . | . | . | . | . | . | . |
| . | . | . | . | . | . | . | . | . | . |
| . | . | . | . | . | . | . | . | . | . |

TABLE 5

| USER | USER | PASS- | | GEN- | CREA- | MEMBER | |
|---|---|---|---|---|---|---|---|
| ID | NAME | WORD | AGE | DER | TOR | RANK | . . . |
| U001 | A | xxxx | 10 | MALE | X | GUEST | . . . |
| U002 | B | xxxx | 21 | FEMALE | X | BRONZE | . . . |
| U003 | C | xxxx | 24 | FEMALE | X | PLATINUM | . . . |
| U004 | D | xxxx | 43 | MALE | X | PLATINUM | . . . |
| U024 | X | xxxx | 32 | MALE | O | | . . . |
| . | . | . | . | . | . | . | . |
| . | . | . | . | . | . | . | . |
| . | . | . | . | . | . | . | . |

TABLE 6

| USER ID | EULA CONSENT STATUS | STAGE | . . . |
|---|---|---|---|
| U001 | X | | . . . |
| U002 | ◯ | 1 | . . . |
| U003 | ◯ | 2 | . . . |
| U004 | ◯ | 5 | . . . |
| . | . | . | . |
| . | . | . | . |
| . | . | . | . |

In addition to the information described in Table 1, the anchor management table corresponding to Table 4 includes an EULA consent status, a stage, and a member rank. The user attribute information management table corresponding to Table 5 includes a member rank in addition to the information described in Table 2, and the user progress information management table corresponding to Table 6 includes a stage in addition to the information described in Table 3. The EULA consent status is information indicating whether consent to EULA is required to use an anchor. The stage is information indicating a progress status of a service that provides a virtual object. The member rank is information indicating a member rank of a user (for example, bronze, gold, platinum, or guest) in the service that provides the virtual object.

The EULA consent status, the stage, the member rank, and the gender managed in the anchor information management table (Table 4) are conditions for determining a method of providing a virtual object to a user. A method of providing a virtual object to the user terminal can be changed on the basis of conditions such as whether or not the user consents to EULA regarding service use, the user's age, the date and time when the user has requested the virtual object from the terminal, and the user's member rank. For example, for a guest user (for example, U001) who does not consent to EULA, a provision method in which another virtual object with EULA different from a virtual object provided to a service member is provided may be determined.

Each process shown in FIG. 7 is realized by the CPU 222 of the virtual object management server 121 reading a program stored in the memory to the RAM 223 and executing the program. In S701, the anchor provision unit 313 receives a virtual object provision request (search request) from the anchor acquisition unit 303 of the client terminal 133. The virtual object provision request received from the client terminal 133 includes at least one of anchor identification information corresponding to the virtual object and feature amounts in the real world, and the user information.

In S702 to S705, the anchor provision unit 313 determines a virtual object to be provided on the basis of the user information included in the virtual object provision request and conditions for determining a method of providing a virtual object managed by the virtual object management server 121 to a user. In S702, the anchor provision unit 313 refers to the user information management table (Tables 5 and 6), and acquires settings based on the progress of the virtual object provision service of the user corresponding to the user information included in the virtual object provision request. The anchor provision unit 313 refers to the anchor management table (Table 4) and narrows down a virtual object to be provided to the client terminal 133 on the basis of the settings based on the user's progress in the virtual object provision service. If the virtual object provision request includes the user information of the user “C”, the anchor provision unit 313 acquires settings based on the progress of the virtual object provision service of the user whose user name is “C” in the user information management table. Specifically, the anchor provision unit 313 acquires the fact that the user whose user name is “C”, that is, whose user ID is “U003”, has consented to EULA and has progressed to stage “2” of the virtual object provision service. The anchor provision unit 313 refers to the anchor management table, and narrows down anchors of a virtual object of which the EULA consent status is “O” and the stage is “2” to anchors of which the anchor IDs are “c” and “d”.

In S703, the anchor provision unit 313 determines whether or not virtual objects to be provided to the client terminal 133 are different depending on attributes of the user for the virtual objects narrowed down in S702. For example, the anchor provision unit 313 determines whether or not virtual objects to be provided to the client terminal 133 are different depending on whether or not values indicating attributes of the user such as a “gender” and a “member rank” in the anchor information corresponding to the narrowed-down virtual objects are different. If values indicating attributes of the user such as a “gender” and a “member rank” in the anchor information corresponding to the narrowed-down virtual objects are different, it is determined that virtual objects to be provided to the client terminal 133 are different depending on the attributes of the user, the process in S704 is performed. On the other hand, if values indicating attributes of the user such as a “gender” and a “member rank” in the anchor information corresponding to the narrowed-down virtual objects are the same, it is determined that virtual objects to be returned are not different depending on the attributes of the user, the process in step S706 is performed.

In S704, the anchor provision unit 313 refers to the user information management table (Tables 5 and 6) and acquires settings (user attribute information) based on the attributes of the user corresponding to the user information included in the virtual object provision request. The settings based on the attributes of the user include, for example, settings based on the user's personal attributes such as a gender, an age, a member rank, an organization to which the user belongs, and settings based on environment to which the user belongs, such as the season and date (a situation in which the user is placed). If user information corresponding to the user “C” is received from the client terminal 133, the anchor provision unit 313 acquires settings based on attributes of the user whose user name is “C” in the user information management table. Specifically, the anchor provision unit 313 acquires information that the user whose user name is “C”, that is, whose user ID is “U003”, has a member rank of “platinum” and a gender of “female”. In S705, the anchor provision unit 313 further narrows down a virtual object to be provided to the client terminal 133 from among the virtual objects narrowed down in S702 on the basis of the settings (user attribute information) based on the attributes of the user acquired in S704. Specifically, on the basis of the fact that the user “C” has a member rank of “platinum” and a gender of “female,” the anchor provision unit 313 refers to the anchor management table and narrows down the anchors with the anchor IDs “c” and “d” to the anchor “d”. The fact that the user has consented to EULA and has progressed to stage “2” of the virtual object provision service is acquired. The anchor provision unit 313 refers to the anchor management table, and narrows down anchors of a virtual object of which the EULA consent status is “O” and the stage is “2” to anchors of which the anchor IDs are “c” and “d”. In S706, the anchor provision unit 313 returns the narrowed-down anchors to the client terminal 133, and thus returns virtual objects corresponding to the anchors to the client terminal 133.

Through the above processes, even in a state in which a plurality of a virtual object are disposed at the same position, an appropriate virtual object for the user terminal can be provided and displayed according to attribute information of a user, a situation in which the user is placed, and a progress status in a service.

In the present embodiment, the virtual object management server 121 narrows down a virtual object to be returned to the client terminal 133, but the client terminal 133 may also narrow down a virtual object. By storing user information (for example, Tables 5 and 6) in the client terminal 133, the client terminal 133 can narrow down a virtual object to be displayed according to conditions based on the user information.

If a creator explicitly instructs a target user to provide a virtual object through push sharing or the like, it is not necessary to check user information of the user in order to provide the virtual object. That is, it is possible to skip the process (S702 to 5705) of determining a virtual object to be provided according to conditions based on the user information and provide an anchor specified by an owner.

As described above, according to the present embodiment, even if a plurality of virtual objects are disposed at the same location, it is possible to provide an appropriate virtual object according to the content of a contract with a user, attribute information such as the user's age, gender, and member rank, and an environment to which the user belongs, such as the date and time. Consequently, it is possible to provide and display a virtual object according to information of a user even if feature amounts are similar to each other. Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A system that manages a virtual object comprising:
a memory storing instructions; and
a processor executing the instructions causing the system to:
manage feature amounts in a real world for displaying a virtual object in linkage with the real world in association with identification information corresponding to the virtual object; and
manage conditions for determining a method of providing the virtual object to a user in further association with the identification information.

2. The system according to claim 1, wherein the system includes a terminal capable of projecting the virtual object into the real world,
the instructions further cause the system to, in response to a request using at least one of the identification information and the feature amounts in the real world and user information from the terminal, return, to the terminal, information regarding the virtual object managed by at least one of the identification information and the feature amounts according to a provision method determined on the basis of the user information and the conditions, and
the terminal projects the virtual object into the real world.

3. The system according to claim 1, wherein the provision method includes providing another virtual object different from the virtual object.

4. The system according to claim 1, wherein the conditions include settings based on progress of a user corresponding to the user information in a service that provides the virtual object.

5. The system according to claim 4, wherein the settings based on the progress of the user include whether or not the user has consented to a contract.

6. The system according to claim 1, wherein the conditions include settings based on personal attributes of a user corresponding to the user information.

7. The system according to claim 1, wherein the conditions include settings based on an environment to which a user corresponding to the user information belongs.

8. The system according to claim 1, wherein the instructions further cause the system to manage identification information of a user in linkage with settings based on progress of the user in a service or settings based on personal attributes of the user.

9. The system according to claim 1, wherein the method of providing the virtual object to the user is set by an owner of the virtual object.

10. The system according to claim 9, wherein, if the owner of the virtual object instructs the user to share the virtual object, the virtual object is provided without checking the conditions.

11. The system according to claim 1, wherein the terminal includes a head mounted display.

12. A control method for a system that manages a virtual object, the control method comprising:
managing feature amounts in a real world for displaying a virtual object in linkage with the real world in association with identification information corresponding to the virtual object,
managing conditions for determining a method of providing the virtual object to a user in further association with the identification information.
